(19) United States
(12) Patent Application Publication
(10) Pub. No.: US 2019/0210882 A1
(43) Pub. Date: Jul. 11, 2019

(54) System and Method for Producing High Purity Particulate Graphite

(71) Applicant: Northern Graphite Corporation, Ottawa (CA)

(72) Inventors: Greg Bowes, Ottawa (CA); Kamal Adham, Ottawa (CA); Sabrina Francey, Ottawa (CA); Darren Kazmaier, Ottawa (CA)

(21) Appl. No.: 16/225,090

(22) Filed: Dec. 19, 2018

Related U.S. Application Data
(60) Provisional application No. 62/613,990, filed on Jan. 5, 2018.

(51) Int. Cl. C01B 32/215; B01J 8/42; B01J 8/18

(52) U.S. Cl. CPC C01B 32/215; B01J 8/42; B01J 8/1818; B01J 2208/00761; C01P 2006/80; B01J 2208/00752; B01J 8/1872

(57) ABSTRACT

A reactor vessel is provided having a solids feed opening for particulate graphite and a product outlet for purified particulate graphite. The vessel has an interior volume for containing the graphite particles, with a plurality of gas feed openings at the bottom of the interior volume, near the centre-line, for feeding of chlorine-containing gas, wherein the chlorine-containing gas passes through the particulate graphite, fluidizing the particulate graphite. Electrodes are provided which function to heat the particulate graphite, as it is carried upwards under the fluidizing effect of the centrally injected chlorine-containing gas. When the heated graphite particles react with the chlorine gas, purified particulate graphite is formed and may be extracted through the product outlet.

### TECHNICAL FIELD

This disclosure relates to the production of high purity graphite. In particular, it relates to the production of high purity particulate graphite using carbo chlorination in a electrical resistance heated fluidized reactor.

### BACKGROUND

Graphite is used as the anode material in lithium ion batteries and is typically of high purity. The demand for high purity graphite for lithium ion batteries is growing rapidly due to the proliferation of small, hand held electronic devices and more recently, the emerging electric vehicle and grid storage markets.

High purity flake natural graphite may be used to make the bi-polar plates in PEM fuel cells and for many other commercial applications.

Many of these applications may require 99.95% C purity levels, or higher, and specific impurities must be reduced to acceptable levels, such as less than 50 ppm Fe (iron) and essentially no metallic elements.

One technique for making high purity natural graphite uses the wet chemical approach which is based on acid (usually HF or H₂SO₄) or caustic (NaOH) leaching. The wet chemical approach typically generates large volumes of effluent which can cause serious environmental challenges and a requirement for expensive treatment processes as well as costly precautions to manage workplace health and safety issues.

Another technique for making high purity graphite is the high temperature thermal treatment method, which uses temperatures of 2400 to over 2700° C. This technique is used commercially for natural graphite but the furnaces may be expensive to build and operate and cause air emissions issues, and the technique may have restrictions on the incoming purity, place difficult demands on the reactor design due to the high temperatures and damage caused by volatiles, and can result in changes to the crystal lattice of the graphite.

Chlorine-based purification has been used for synthetic graphite articles (non-particulate material), at lower temperatures, in a batch fixed bed process. This technique has had limited commercial application and has the challenges of being expensive and providing low production capacity (<50 kg/h) due to the long cycle times needed for heating and cooling of the non-particulate synthetic graphite articles.

Historically, chlorine-based processes for natural particulate graphite purification have been proposed but have not had wide commercial application because of the costs associated with high reagent consumption, long furnace retention times, batch processing and the requirement for catalysts and other chemicals have made them uneconomic. Also, high purity levels often could not be achieved and the corrosive nature of chlorine at high temperature caused mechanical, structural and safety problems with the furnaces.

There is therefore a need for an efficient, non-acid based, moderate temperature system and method for producing high purity graphite.

### SUMMARY

Thus, in one aspect of the present invention, a reactor is provided for purification of particulate graphite comprising a reaction vessel having a feed opening or inlet for particulate graphite and a product outlet for purified graphite. The vessel has an interior volume for containing the particulate graphite and a feed opening or inlet for chlorinated gas to fluidize the particulate graphite. The reactor further comprises at least two electrodes adapted to extend into the particulate graphite within the vessel, such that electricity may pass through the particulate graphite, heating the particulate graphite. When the heated particulate graphite reacts with the chlorine gas, purified graphite is formed and may be extracted through the product outlet.

In a further aspect of the invention, a method of purifying fluidizable particulate graphite is provided comprising: introducing the fluidizable particulate graphite into an interior volume of a reaction vessel; introducing a chlorine-containing fluidizing gas into the bottom of the interior volume of the reaction vessel to fluidize the particulate graphite; heating the fluidized particulate graphite using at least two electrodes submerged within the fluidized particulate graphite such that a carbochlorination reaction occurs removing impurities from the particulate graphite; and removing purified graphite from the interior volume of the vessel.

### BRIEF DESCRIPTION OF THE DRAWINGS

In drawings which illustrate by way of example only various embodiments of the disclosure,

FIG. 1 is a representation of a reactor in accordance with an embodiment of the disclosure.

FIG. 2 is a representation of a reactor with an inert gas behind an inner graphite lining in accordance with an embodiment of the disclosure.

FIG. 3 is a representation of a reactor enclosed within an external vessel in accordance with an embodiment of the disclosure.

### DETAILED DESCRIPTION

The detailed description set forth below in connection with the appended drawings is intended as a description of various embodiments of the present disclosure and is not intended to represent the only embodiments contemplated. The detailed description includes specific details for the purpose of providing a comprehensive understanding of the present disclosure. However, it will be apparent to those skilled in the art that the present disclosure may be practised without these specific details.

A reactor is provided for purification of particulate graphite and may be useful to provide graphite of a purity that is greater than 99 wt % carbon, for example, a purity of greater than 99.5% wt % carbon or a purity that may be greater than 99.95 wt % carbon. The reactor advantageously allows for continuous purification of particulate graphite at large-scale production capacity levels. In addition, the reactor is designed to heat and maintain the graphite at a desired temperature without the use of combustion heating, which can result in an associated loss of graphite value, but instead provides an electric resistance heated fluidized bed.

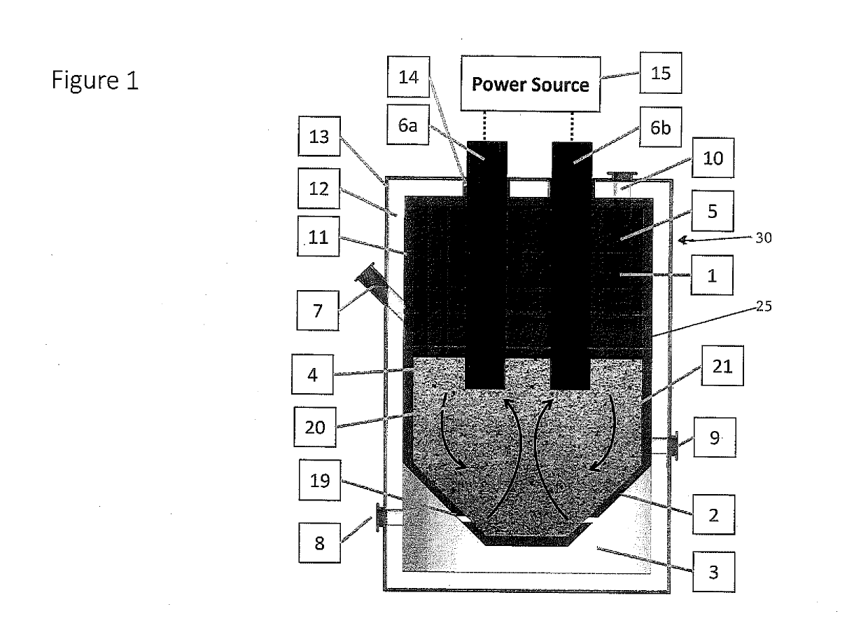

With reference to FIG. 1, a reactor 30 is shown which comprises reaction vessel 25 having an interior volume 1 for containing particulate graphite and a bottom 2 oriented above a windbox 3. The windbox 3, a hollow region beneath the vessel 25, provides for the feeding of fluidizing gas, such as chlorine-containing gas, preferably continuously, into the interior volume 1 through a plurality of gas openings or nozzles 19 formed in the bottom 2 of the vessel 25. The interior volume 1 houses a bed of fluidized graphite 4, once graphite and fluidizing gas is fed into the vessel 25, and freeboard 5.

The reactor 30 includes an opening or inlet 7 for feeding particulate graphite into the interior volume 1 of vessel 25 and the reaction zone 20. The reactor also includes an opening 8 for feeding chlorine-containing fluidizing gas into the windbox 3. The reactor 30 additionally includes an outlet 9 for withdrawing purified particulate graphite product from the bed of fluidized graphite 4. The reactor 30 further includes an off-gas outlet 10 for withdrawal of process off-gases comprising impurities from the graphite (such as metal oxide impurities) from the freeboard zone 5 of the reactor 30.

The bottom 2 of the vessel preferably comprises downwardly slanting walls, e.g. may be conically or approximately conically-shaped. The gas openings 19 may be near the approximate centreline of the interior volume 1 of vessel 25, along the angled sides of the bottom 2 of the vessel. The side introduction of chlorine-containing fluidizing gas along the angled sides of the conical bottom 2 reduces the sifting (fall through) of graphite particles through the openings 19. The openings 19 may be formed in a perforated-plate bottom distributor. This arrangement does not need expensive and high maintenance tuyeres, such as club-head injectors.

The near-centre introduction of chlorine-containing fluidizing gas also enhances mixing of fluidizing gas and graphite within the vessel, creating an internal circulation of graphite particles, as indicated by the arrows in FIG. 1. The central chlorine-containing fluidizing gas plume picks up the particles near the centre and moves them to the region between the two electrodes, the central reaction zone 20, which may be the hottest region in the bed of fluidized graphite 4. The particles may then flow towards the reactor wall, which may be the coldest region in the bed of fluidized graphite 4.

With reference to FIG. 1, this flow of gas and fluidized graphite can maximize the chlorine utilization in the hottest region of the fluid bed (the central reaction zone 20) while minimizing the chlorine concentration and temperature near the reactor wall, thus providing for a significantly longer-lasting reactor internal enclosure.

The reactor 30 includes electrodes 6 that protrude into the interior volume 1 of vessel 25 to be in direct contact with, e.g. submerged in, the bed of fluidized graphite 4. Electrodes 6 may be made of high purity graphite, e.g. 99.5% graphite with less than 0.5% ash. Electrodes 6 are connected to a suitable power source 15 to provide electricity to the electrodes. Power may be supplied to the electrodes 6 using a versatile power source, either an AC or DC electrical power source, that is responsive to variations in resistive loads within the vessel and permits control of bed temperature. In one embodiment, two vertical in-bed retractable electrodes may be used such as vertical retractable in-bed electrodes 6a, 6b, as shown. In another embodiment, three vertical in-bed retractable electrodes may be used, each attached to a different phase of a three-phase electrical supply.

The electrodes 6 are configured to allow electrical current to pass through the particulate graphite in reaction zone 20 near the center of the reactor vessel. The flow of current through the particulate graphite causes resistance heating of the particulate graphite, particularly near the center of the reactor where most of the chlorine-containing gas is flowing upwards from the gas openings 19.

The interior volume 1 of vessel 25 may have an inner lining 11 to reduce the contamination of the product. Graphite, e.g, high purity graphite (99.5% graphite with less than 0.5% ash), may be used as a lining because it is resistant to chemical attack by chlorine. The lining may also act as a conducting electrode.

The inner lining 11 preferably is surrounded by one or more refractory layers 12 that are thermally and electrically insulating. As an example, the refractory layer may be made from aluminosilicate, silicon carbide or nitride; however, aluminosilicate is preferred due to increased resistance to chlorine attack. The windbox 3 may also have a refractory layer 12 that is thermally and electrically insulating.

The one or more refractory layers 12 are preferably surrounded by an outer shell 13 to provide an impermeable gas seal against possible leakage of chlorine through the inner lining 11 and refractory layers 12. The outer shell may be metallic, for example the outer shell 13 may be made from mild or stainless steels. The outer shell 13 is protected from the thermal and electrical conditions of the vessel by the one or more refractory layers 12.

Components of the reactor vessel 25, other than the electrodes, which should not be in electrically conductive contact with the electrodes or the power lines bringing electric power to the electrodes, are electrically isolated. For example, electrode seals mechanically connect the electrodes to the reactor body while providing electric isolation and seal the electrodes against the chlorine atmosphere inside the reactor.

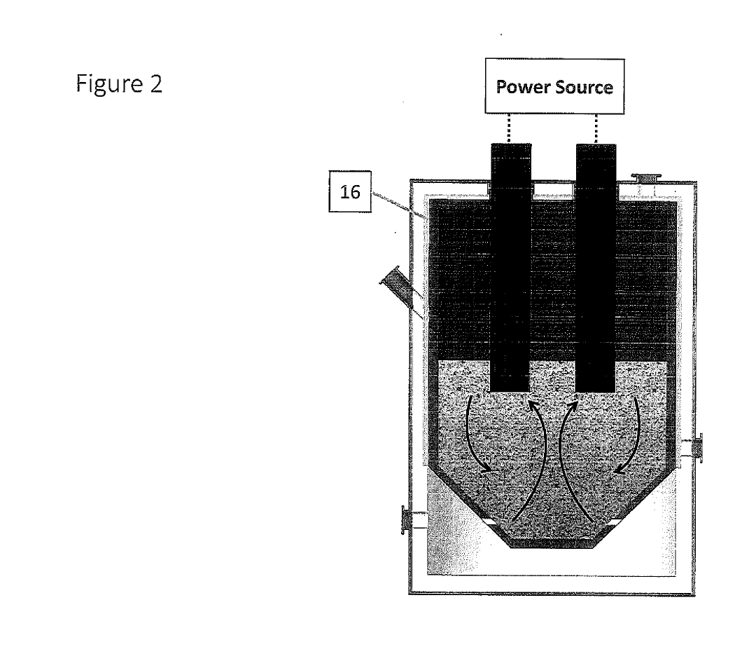

With reference to FIG. 2, in an embodiment, a reactor 30 is provided similar to that described above including a cavity 16 between the inner graphite lining 11 and the refractory layer 12. Inert gas such as nitrogen, may be injected into cavity 16 to protect the graphite liner from oxidation.

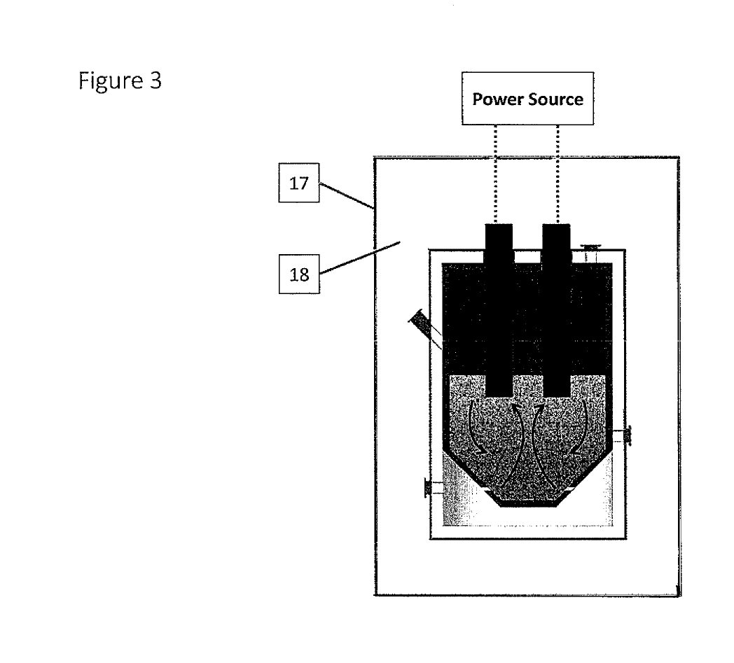

With reference to FIG. 3, in an embodiment, a reactor 30 is provided similar to that described above enclosed within an external vessel 17 filled with inert gas 18 in the space between the external vessel 17 and the outer shell 13.

The graphite material to be purified in the reactor 30 is particulate graphite of a lower purity, i.e. less than 99.95% graphite, that has a particle size range that is fluidizable. Particulate graphite refers to graphite, both synthetic and natural, that is in granular form. Examples of particulate graphite include, but are not limited to, flake and micronized natural graphite of all sizes. Thus, the size of the particles may be from less than 10 to more than 1000 microns in diameter. Fluidizable means the particles are suspended and act in many respects like a fluid.

The particulate graphite fed into the reactor 30 is fluidized with chlorine-containing gas supplied to the reactor. The particulate graphite undergoes carbochlorination reactions with the chlorine-containing fluidizing gas. The carbochlorination reactions result in the removal of impurities in the gaseous state from the particulate graphite.

The stoichiometric ratio of chlorine with respect to impurities is preferably more than 1. The amount of chlorine-containing gas required for the carbochlorination reactions in the present method is less than that required in traditional graphite batch purification processes using chlorine due to the mixing action of the fluidized bed, which minimizes the amount of excess chlorine departing with the off-gas. The chlorine concentration may be up to 100% in feed gas. Chlorine may be blended with an inert earner gas, such as nitrogen, for better fluidization velocity and temperature control.

Chlorine may be further blended with a reducing agent such as carbon monoxide, for better oxygen removal from oxide impurities and to limit the consumption of graphite in the carbochlorination reactions. In addition, the chlorine-containing gas may be blended with a catalyst, such as CCl₄, to accelerate the reaction rate. One advantage of fluidization is that it provides improved gas/solids mixing which provides efficient chlorine use, while also providing a simple means of continuous feeding and discharging of the particulate graphite.

The present reactor may be operated as a batch process, or preferably, may be operated continuously with particulate graphite being added and purified particulate graphite being removed from the reactor at the same time. Depending on the initial purity and particle size, the residence time for the particulate graphite in the reactor is sufficient to permit reaction of impurities within the graphite, and may be from less than 20 minutes to more than 200 minutes. Thus, the greater the initial purity, the lower the reactor residence time.

The reactor may be operated at temperatures below 1700° C. The use of chlorine to chlorinate impurities allows the reactor operating temperature to be lower than some prior thermal graphite treatment processes (which may be operated at temperatures of up to or greater than 2500° C.). Due to the relatively lower operating temperature of the reactor, construction of the fluidized bed is significantly more manageable than that of other reactors.

The reactor may be operated at a process pressure of less than an inert (e.g. N₂) atmosphere pressure. The process pressure may be contained by an inert gas injection 16 between the vessel's inner lining 11 and the refractory layer 12 as shown in FIG. 2. The process pressure may be maintained by enclosing the entire process vessel within an external vessel 17 filled with the inert gas, with reference to FIG. 3.

The reactor will preferably be operated in the gas velocity range that results in a gentle bubbling fluidization regime in order to maximize the particulate graphite circulation and the gas/solid mixing. Fluidization is the particulate solid's state when the buoyancy of upward gas flow is adequate to counter the downward gravitational pull on the particles, in order to suspend them in a fluid-like condition. Bubbling regime is when all the solid particles are gently fluidized with gas flowing through them in the form of small gas bubbles.

Elutriated graphite dust that exits the reactor 30 with the process off-gases may be captured using a dust separator, for example, a cyclone. The captured graphite dust may be combined with the purified particulate graphite that is withdrawn as product from the reactor, or may be recycled back into the reactor for further purification.

Nitrogen purging of product and dust outlets may be provided to reduce the risk of the product being contaminated with residual chlorine or volatile chlorides. Purging with nitrogen may also reduce undesired oxidation of the hot graphite particles.

Without limitation to theory, the following is a description of the process chemistry relating to this disclosure.

The chlorination of metal oxide impurities in graphite, to convert the metal oxides to chlorides, allows for the evaporation and removal of metal impurities at much lower temperatures than in their oxide form.

For example, titanium dioxide (TiO₂) generally chlorinates at temperatures greater than 900° C., and the resultant titanium tetrachloride (TiCl₄) has a low boiling point at atmospheric pressure of 136° C., whereas the original oxide (TiO₂) has a high boiling point at atmospheric pressure of 2500-3000° C. Therefore, the use of chlorination allows for a significant decrease in the required temperature for thermal treatment and removal of metal oxide impurities in graphite. Chlorine, like all halogens, can pass through the honeycomb like molecular structure of graphite at elevated temperatures to access and remove impurities.

The chlorination of metal oxides (MO₂) by chlorine is represented generically by the equation below:

MO₂+2Cl₂=MCl₄+O₂

The Gibbs free energy change for the above reaction is positive, suggesting that the reaction is non-spontaneous and does not proceed, at most temperatures because oxides are generally more stable than chlorides.

In order to convert metal oxides to chlorides in a thermodynamically favourable manner, the chlorination reaction may be combined with a reduction reaction. A carbon-based reducing agent, such as carbon (C) or carbon monoxide (CO) is used. The combined reduction-chlorination reactions using carbon-based reducing agents may be referred to as carbochlorination.

Generic equations for carbochlorination of metal oxides are provided below, as well as silica (SiO₂):

Metal oxide with carbon as a reducing agent:

MₐO_{b}+(b/2)C+bCl₂=aMCl_{(2b/a)}+(b/2)CO₂

and reaction with the impurity silica (SiO₂) where a=1, b=2:

SiO₂₍ₛ₎+C₍ₛ₎+2Cl_{2(g)}=SiCl_{4(g)}+CO_{2(g)}

with carbon monoxide as a reducing agent:

MₐO_{b}+bCO+bCl₂=aMCl_{(2b/a)}+bCO₂

and reaction with the impurity silica (SiO₂) where a=1 and b=2:

SiO₂₍ₛ₎+2CO_{(g)}+2Cl_{2(g)}=SiCl_{4(g)}+2CO_{2(g)}

In addition to carbochlorination reactions, the Boudouard reaction equilibrium (C₍ₛ₎+CO_{2(g)}=2CO_{(g)} may also be prevalent. The equilibrium is a function of temperature.

Carbon itself is not easily chlorinated to carbon tetrachloride. This reaction has a positive Gibbs free energy (non-spontaneous) at temperatures above 500° C. Since carbochlorination typically takes place at much higher temperatures, it is a convenient means of removing metal oxide impurities from graphite.

However, the carbon (C) noted in the above reactions is drawn from the graphite itself, meaning that carbochlorination can consume a small portion of the graphite. It can therefore be advantageous to blend carbon monoxide (CO) with the chlorine (Cl₂) fed to the reactor, to act as a supplementary reducing agent and to shift the Boudouard equilibrium to the left, thereby decreasing the amount of graphite consumed.

The effective carbochlorination temperature differs among the various metal oxides. The effective temperature may also be a function of the amount of excess chlorine provided to the reaction environment, where increasing the amount of excess chlorine provided is found to lower the required temperature to achieve a given conversion of the metal oxide for a given retention time. Thus, there exists a trade-off in chlorination processes between excess chlorine and the reaction temperature.

Carbochlorination is an exothermic reaction, and it is possible for large-scale carbochlorination reactors processing metalliferous ores to be able to operate autothermally once they are brought up to temperature. The reactor uses the heat of the reaction to maintain the reactors temperature.

For graphite purification, the particulate graphite to be purified may have a very low metal oxide content, such as less than 5 wt % in graphite mine concentrates. In this case, to purify graphite, an additional source of heat may be advantageous to maintain the reactor temperature at a level high enough to sustain carbochlorination. Preferably, this additional source of heating should avoid the combustion of the graphite itself.

### EXAMPLES

The following exemplifies use of a reactor in accordance with an embodiment of the invention and is not to be construed as limiting.

### Example 1

Experiments were conducted to purify particulate graphite material of 95-98% carbon. The impurities were mainly biotite, silica and pyrite.

Experiments 1-25 were completed in a reactor consisting of a silicon carbide tube with a high purity graphite liner resulting in an 1.75″ inside diameter. Process batches were 100-150 grams in size. Experiments 26-38 used a 4.7″ inside diameter reactor which also had a high purity graphite lining which enabled 800-900 gram samples to be processed.

Both flake graphite (+50 mesh, +50 to −80 mesh and −100 mesh) and micronized and rounded “spherical” graphite (10 to 20 microns) were tested.

Improved gas/solids contact was obtained by inserting a graphite lifter cage assembly inside the graphite liner and slowly rotating the reactor to partially mimic the effect of using a fluid bed reactor.

Process feed gases were injected upstream of the reactor at specified flow rates. The process off-gas was passed through a caustic (NaOH solution) impinge to neutralize any excess chlorine in the gas stream. The gas stream leaving the impinge was flared to combust any CO before exiting the hood and entering the atmosphere.

Chlorine gas was passed through a horizontal rotary batch kiln at 1250-1550° C. Flow rates, retention time and temperature were evaluated. Exemplary results/conditions are shown in Table 1.

TABLE 1

| Sample | Experiment | Temperature | Retention | Cl₂ addition | Starting | Ending |
|---|---|---|---|---|---|---|
| ID | Number | (° C.) | time (min) | (cm³/min) | Purity (% C) | Purity (% C) |
| Coarse | 6 | 1,450 | 30 | 182 | 98.68 | 100 |
| SPG* | | | | | | |
| Fine SPG | 10 | 1,450 | 30 | 182 | 98.28 | 100 |
| −100 | 38, 39 | 1,450 | 30, 45 | 1,243/364 | 95.86 | 99.73 |
| flake | | | | | | |
| 50 × 80 | 41 | 1,450 | 30 | 357 | 97.95 | 99.06 |
| flake | | | | | | |
| +50 flake | 60 | 1,550 | 30 | 216 | 97.83 | 99.99 |
| Ultra fine | 58 | 1,450 | 30 | 170 | 98.09 | 99.99 |
| flake | | | | | | |

*spherical graphite

### Conclusions

1. Graphite was successfully purified to a purity of greater than 99 wt % carbon. Spheronized graphite was successfully purified to 99.95 wt % carbon at a temperature of 1,450° C. using a 30 minute retention time and a chlorine flow rate of 182 cm³/min. Extra-large+50 mesh flake was successfully purified to 99.99 wt % carbon at a temperature of 1,550° C., a 30 minute retention time and a chlorine flow rate of 216 cm³/min.

2. Successful purification was achieved with and without the addition of NaCl and CO and therefore those process inputs are not required.

### Example 2

Flake graphite concentrates from five other natural graphite deposits were converted into spherical graphite (“SPG”) and purified using the present purification process under standard conditions. Three of the samples were from Chinese deposits, one from South America and another from North America.

The 4.7″ silicon carbide rotating batch reactor as described in Example 1 with a high purity graphite insert and lifters was used. All tests were done using 600-800 g batches at 1,450° C., a Cl₂ flow rate of 2.3 sL/min and a retention time of one hour.

As shown in Table 2, all samples were successfully purified to a purity of greater than 99.95% C.

TABLE 2

| | | Starting Purity | Ending Purity |
|---|---|---|---|
| Sample | Experiment Number | (% C) | (% C) |
| Northern | 1 | 97.36 | 99.99 |
| South America | 2 | 97.61 | 99.97 |
| North America | 3 | 95.98 | 100 |
| China | 4 | 96.87 | 100 |
| China 1 | 5 | 96.65 | 100 |
| China 2 | 6 | 96.59 | 100 |

The process was also successful in reducing Fe contents to very low levels. An ash analysis of the +50 mesh purified graphite product was as follows:

TABLE 3

| MATERIAL: | 50 Mesh Purified X- Flake |
|---|---|
| SUPPLIER: | Northern Graphite |
| SUPPLIER LOT NO: | C14-0027 |
| Element | PPM |
| Ag | <.0040 |
| Al | 5.033 |
| As | <.0050 |
| B | 1.212 |
| Ba | 0.1145 |
| Bi | 5.887 |
| Ca | 46.14 |
| Cd | <.0020 |
| Co | <.0020 |
| Cr | 0.1346 |
| Cu | 3.564 |
| Fe | 3.502 |
| Ga | <.0200 |
| In | 0.624 |
| K | 3.096 |
| Mg | 11.89 |
| Mn | 0.0335 |
| Mo | 1.725 |
| Na | 23.89 |
| Ni | <.0060 |
| P | 1.261 |
| Pb | <.0060 |
| S | 11.65 |
| Sb | 0.1578 |
| Si | 2.947 |
| Sn | <.0040 |
| Ti | 0.0504 |
| V | 0.0299 |
| W | 0.5298 |
| Zn | 4.87 |
| Zr | 0.0265 |
| TOTAL | 128.37 |
| MOISTURE CONTENT (%) | 0.06 |
| ASH CONTENT (%) | 0.41 |
| EXPANSION (CC/G) | 604 |
| SULFUR CONTENT (PPM) | 53 |
| LEACHABLE CHLORIDE | 26 |
| (PPM) | |
| LEACHABLE FLUORIDE | <1 |
| (PPM) | |

Various embodiments having been thus described in detail by way of example, it will be apparent to those skilled in the art that variations and modifications may be made. The disclosure includes all such variations and modifications as fall within the scope of the appended claims.

1. A reactor for the purification of fluidizable particulate graphite comprising:
a reaction vessel comprising an interior volume for containing the particulate graphite, a solids feed inlet to feed particulate graphite into the interior volume of the vessel, a product outlet for withdrawal of purified particulate graphite from the vessel, a plurality of gas feed openings formed in the bottom of the reaction vessel for feeding chlorine-containing fluidizing gas into the interior volume of the vessel to fluidize the particulate graphite and an off-gas outlet for withdrawal of process off-gases from the vessel; and
at least two electrodes that extend into the interior volume of the vessel so as to be submerged in fluidized particulate graphite in the vessel, said electrodes being adapted to heat the particulate graphite.

2. The reactor of claim 1, wherein the electrodes are vertically oriented.

3. The reactor of claim 1, wherein the bottom of the vessel comprises downwardly slanted edges and the plurality of gas feed openings are formed in the slanted edges near the centre of the vessel bottom.

4. The reactor of claim 1, wherein the electrodes comprise high purity graphite.

5. The reactor of claim 1, wherein the vessel comprises an inner lining made of high purity graphite.

6. The reactor of claim 1, comprising one or more thermally and electrically insulating refractory layers substantially surrounding the vessel.

7. The reactor of claim 1, comprising an outer metallic shell that substantially surrounds the vessel.

8. The reactor of claim 6, further comprising an inert gas between an inner lining of the vessel and the one or more refractory layers.

9. The reactor of claim 1, further comprising a dust separator that separates any elutriated graphite dust that exits the off-gas outlet from the gases.

10. The reactor of claim 1, comprising a windbox that supplies the chlorine-containing fluidizing gas into the vessel through the gas feed openings.

11. The reactor of claim 6, wherein the one or more refractory layers comprise aluminosilicate, silicon carbide or nitride.

12. The reactor of claim 1, wherein the reaction vessel is enclosed within an external vessel filled with the inert gas.

13. A method of purifying fluidizable particulate graphite comprising:
introducing the fluidizable particulate graphite into an interior volume of a reaction vessel;
introducing a chlorine-containing fluidizing gas into the bottom of the interior volume of the reaction vessel to fluidize the particulate graphite;
heating the fluidized particulate graphite using at least two electrodes submerged in the fluidized particulate graphite such that a carbochlorination reaction occurs removing impurities from the particulate graphite; and
removing purified graphite from the interior volume.

14. The method of claim 13, which is a continuous.

15. The method of claim 13, wherein the particulate graphite has a particle range of less than 10 microns to more than 1000 microns in diameter.

16. The method of claim 13, wherein the stoichiometric ratio of chlorine in the fluidizing gas with respect to any impurities in the particulate graphite is more than 1.

17. The method of claim 13, wherein the chlorine-containing fluidizing gas further comprises one or more of an inert carrier gas, a reducing agent or a catalyst.

18. The method of claim 13, wherein residence time for the particulate graphite in the vessel is between 20 minutes and 200 minutes.

19. The method of claim 13, wherein the temperature of the interior volume of the reaction vessel is less than 1700° C.

20. The method of claim 13, wherein the fluidizing gas in introduced into the reaction vessel with gentle bubbling fluidization.
